(19) United States
(12) Patent Application Publication
(10) Pub. No.: US 2008/0035153 A1
(43) Pub. Date: Feb. 14, 2008

(54) FACEMASK ROLL AND METHOD FOR MANUFACTURING THE SAME

(76) Inventor: Flora Lin, Jhu Dong (TW)

Correspondence Address: RABIN & Berdo, PC, 1101 14TH STREET, NW, SUITE 500, WASHINGTON, DC, 20005, US

(21) Appl. No.: 11/464,409

(22) Filed: Aug. 14, 2006

(51) Int. Cl. B65H 5/28; A62B 18/02; A62B 18/08

(52) U.S. Cl. 128/206.27; 128/206.21; 221/70

(57) ABSTRACT

The invention is to provide a facemask roll made of elastic nonwoven fabric for the merits of collecting the masks continuously during the manufacturing process and the convenience of dispensing the facemasks to users. The method of manufacturing comprises feeding one or multiple pieces of elastic nonwoven fabric, layering and folding, welding and sealing, die-cutting, punching, winding on a core, and finishing with determined quantity to make a roll.

### FIELD OF THE INVENTION

The invention relates to a facemask roll, and more specifically, to a roll of facemasks made of elastic nonwoven fabric, and its configuration is suitable for continuously collecting the masks around a roll during the manufacturing process and for continuously dispensing to users.

### BACKGROUND OF THE INVENTION

The elastic nonwoven fabric is suitable for making masks conveniently by cutting the ear-loops right from the fabric without the need of attaching latex or rubber straps. A simple plane mask is made by cutting the fabric in a rectangular strip with extended ear-loops on two ends and a filtration portion in the center, or a butterfly folded type facemask as described in the U.S. Pat. No. 6,615,838 and Japan Patent 3,660,036. These facemasks have a center filtration portion with extended ear-loops on two ends. The center filtration portion is to cover the wearer's nose and mouth when in use, and the ear-loops are used to fasten onto the wearer's ears. Conventionally, these masks are made separately, then gathered and packaged in another process. As a result, it takes an additional apparatus and a longer procedure and causes a higher production cost. Additionally, for the hygienic concern, these facemasks, currently packed in a stack, are difficult for users to take without disturbing the others. The present invention is to provide facemasks in a roll form to overcome the foresaid disadvantages.

### SUMMARY OF THE INVENTION

Conventionally, the plane type facemasks are made by press-die cutting from a stack of elastic nonwoven fabric, and the butterfly folded type facemasks, described in U.S. Pat. No. 6,615,838 and Japan Patent 3,660,036, are made using a continuous die-cutting method. The facemasks in the above described methods are made separately and collected as a stack and packed in a separate process with an additional apparatus. This invention is to provide a facemask roll for continuously collecting the facemasks in the manufacturing process and continuously dispensing the facemasks to the users. Another objective of this invention is to provide the designs of facemask that can be made continuously with one integrated procedure, by feeding the roll of elastic nonwoven fabric through the converting processes continuously and winding up the finished masks around a roll.

The method for making the facemask roll of the plane type mask comprises of continuously feeding, layering and folding (optional), rotary die-cutting the elastic nonwoven fabric along the machine direction to make multiple facemasks that are connected to each other with connection points, and continuously winding these masks around a roll. The method of making the mask roll of butterfly folded type masks comprises of continuously feeding, layering and folding, sealing, and die-cutting the elastic nonwoven fabric along the machine direction to make multiple facemasks that are connected to each other and then winding them around a roll. As a result, these facemasks are made and collected continuously into a roll, and each facemask is adapted to be gripped only one piece at a time by the user for dispensing.

To achieve the foregoing objectives, in accordance with the present invention, there is provided the facemasks made of elastic nonwoven fabric. The facemask roll relating to the invention includes a plurality of elastic nonwoven facemasks having a filtration portion in the center, for covering the wearer's nose and mouth when in use, with extended ear-loops on two ends of the filtration portion to fasten onto the wearer's ears, wherein the facemask roll is characterized in that each molded facemask is connected successively with connection point(s). Thus, each facemask wound in the roll is connected to each other, thereby forming a roll having a continuous flat strip of facemasks with the facemask in an open or folded form. As such, it is convenient for users to tear off a facemask from the facemask roll adapted to be gripped by users' hands.

There are four embodiments to manufacture a facemask roll with above-mentioned objectives. The first embodiment for making facemask roll of a plane type mask that has a flat filtration portion in the center, for covering the nose and mouth when in use, with extended ear-loops on two ends of the filtration portion to fasten onto the wearer's ears. The embodiment comprises the following steps:
(a) a process of feeding in which a piece of elastic nonwoven fabric is unwound and delivered;
(b) a process of die-cutting in which the elastic nonwoven fabric is molded with the outlines of the facemask and the ear-loops and the adjacent perforated border lines between masks. The connection point(s) on the perforated border lines, which connect one mask to the next, make the masks possible to be torn apart;
(c) a process of winding up in which the continuous flat strip of facemasks, a plurality of outlined facemasks with perforated adjacent border lines, is wound around a roll.
   It is a continuous process in which step (a) to step (c) is repeated until the pre-determined quantity of facemasks is achieved, reaching the purpose for providing a facemask roll. The elastic nonwoven fabric used can be a multiple layered structure before entering the step (a). And, in the step (c), the outlines of the face mask and the ear-loop can be a solid or perforated form; thus, it is convenient for users to tear off a facemask from the mask roll from the perforated border lines and then remove the trims in the ear-loops and between the mask outlines.

With integrating the foresaid processes, a facemask roll made up with a plurality of facemasks in a continuous flat strip is finished, and the method for dispensing them is similar to the toilet paper dispensing system. As such, these facemasks are conveniently dispensed and can be torn off one by one from the roll.

The second embodiment discloses a method for manufacturing the facemask roll of the plane type mask, comprising steps mostly the same as those of the first embodiment, characterized by an additional layering and folding process, before the die-cutting process, for folding a full width elastic nonwoven fabric symmetrically along its laterally central line or laying two pieces of half width elastic nonwoven fabric together and sealing them on one side to become a symmetrically folded double layer. With integrating the foresaid processes, a facemask roll made up with a plurality of folded facemasks in a continuous flat strip is finished.

The third embodiment is for making facemask roll of a butterfly folded type mask that has a filtration cup in the center portion, for covering the nose and mouth while in use, with extended ear-loops on two ends of the filtration cup to fasten onto the wearer's ears. This embodiment comprises the following steps:
(a) a feeding process in which one or multiple pieces of elastic nonwoven fabrics are unwound and delivered;
(b) a layering and folding process in which the full width elastic nonwoven fabric is folded symmetrically along its laterally central line, or two pieces of half width elastic nonwoven fabric are layered together and sealed on one side, to become a symmetrically folded double layer structure;
(c) a sealing process in which the double-layered elastic nonwoven fabric is welded by heating or using an ultrasonic device on an upper side line (nose line) and a lower side line (chin line) to form the filtration cup of the facemask;
(d) a die-cutting process in which the sealed double-layered elastic nonwoven fabric is molded with perforated outlines of the face mask, ear-loops, and the adjacent borders between masks. The perforated border lines, which connect one mask to the next, make the masks possible to be torn apart;
(e) a winding up process in which the continuous flat strip of facemasks, a plurality of outlined facemasks and perforated adjacent borders, is wound around a roll;
   It is a continuous process in which step (a) to step (e) is repeated until the pre-determined quantity of facemasks is achieved. With integrating the foresaid processes, a facemask roll made up with a plurality of folded facemasks in a continuous flat strip is finished.

In the step (d), the outlines of the face mask and the adjacent border lines are die cut to perforated form; thus, it is convenient for users to tear off a mask from the roll from the perforated border lines and then tear off the trims in the ear-loops and between the mask and the adjacent borders.

The fourth embodiment discloses a method for manufacturing the facemask roll, comprising steps mostly the same as those of the third embodiment, characterized in that a plurality of molded facemasks connected to each other without trims is fed into the winding up process to make a roll. As such, users may tear off a facemask from the roll and use it immediately without the need of taking off trims. In the step (c), not only an upper side line (nose line) and a lower side line (chin line) of the facemask but also the connecting points between the masks are welded by the ultrasonic method. The following step (d) is a die cutting to mold the outlines of each facemask. Then, it is further passed through a punching process (d1) to remove the trims between masks and adjacent border lines. Afterwards, proceeding with the remaining steps (e) and (f), a plurality of folded facemasks connected sequentially is continuously wound around a roll, and a mask roll is finished. All facemasks contained in the mask roll can be dispensed and torn off continuously from the roll by tearing at the connecting points but without the necessity of removing trims. As such, each facemask is adapted to be convenient for dispensing and wearing.

The important features of the invention have been outlined above rather broadly, so that the detailed description that follows may be better understood and the present contribution to the art may be better appreciated. There are, of course, additional features of the invention that will be described hereinafter and which will form the subject matter of the claims appended hereto.

### BRIEF DESCRIPTION OF THE DRAWINGS

The foregoing aspects, as well as many of the created advantages and features of this invention will become more apparent by reference to the following detailed description, when taken in conjunction with the accompanying drawings, wherein:

FIG. 1 is a flowchart illustrating the manufacturing method of the present invention;

FIG. 2 is a schematic diagram illustrating the manufacturing process and a perspective view of the first preferred embodiment in accordance with the invention;

FIG. 3 is a schematic diagram illustrating the manufacturing process and a perspective view of the second preferred embodiment in accordance with the invention;

FIG. 4 is a schematic diagram illustrating the manufacturing process of the third and the fourth preferred embodiment;

FIG. 5 is a perspective view of the third preferred embodiment in accordance with the invention; and

FIG. 6 is a perspective view of the fourth preferred embodiment in accordance with the invention.

### DETAILED DESCRIPTION OF SOME EMBODIMENTS

The foregoing aspects and other objectives, features and advantages of the present invention will be much better understood upon consideration of the following detailed first and second preferred embodiment's descriptions when taken in conjunction with the following drawing.

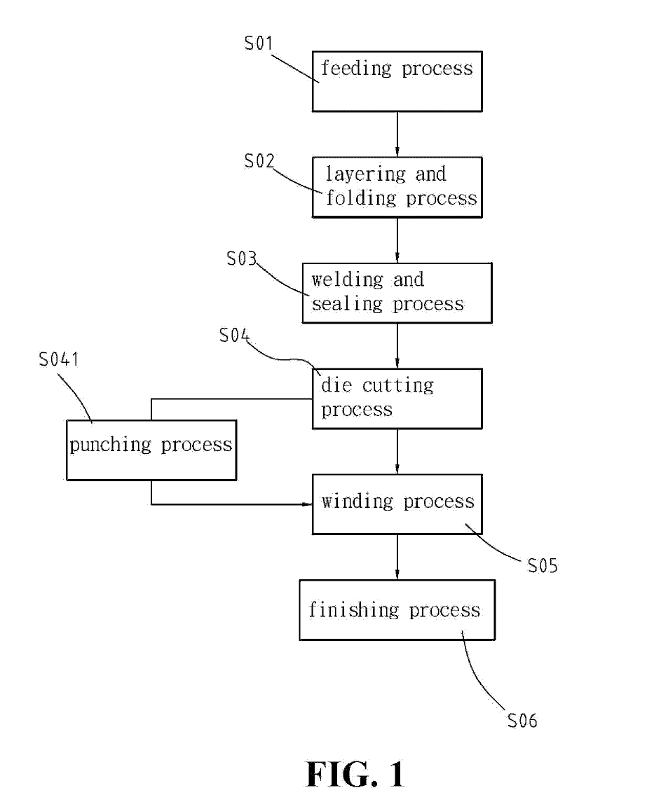

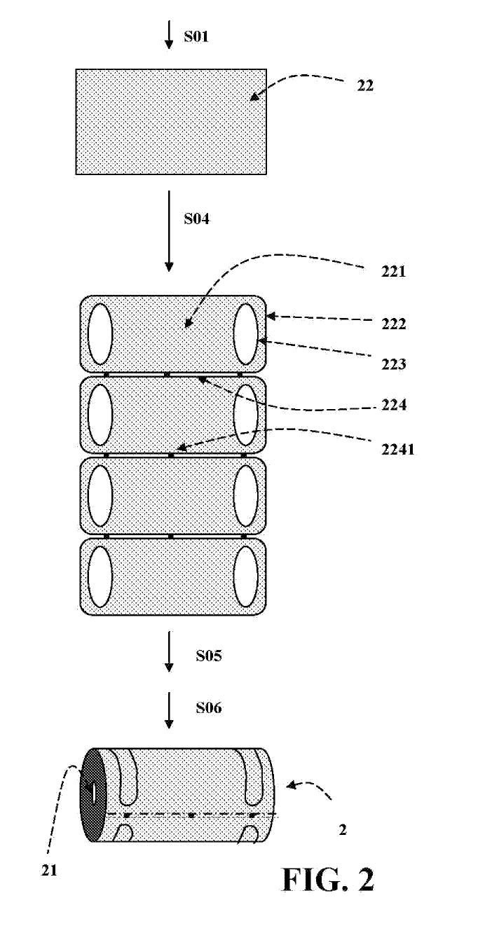

With reference to FIG. 1 and FIG. 2, FIG. 1 depicts a flowchart illustrating the manufacturing method, as used herein, and FIG. 2 shows the manufacturing schematic view to make a facemask roll of a plane facemask. The invention describes a method of manufacturing a facemask roll, and the method comprising the following steps:
(a) a process S01 of feeding delivers the elastic nonwoven fabric 22 continuously with an unwinding system;
(b) a process S04 of die cutting in which the fabric 22 is passed through a molded die to cut the outlines 222 of the mask and ear-loop line 223 to form a complete plane facemask 221 and the perforated adjacent border lines 224 (shown in FIG. 2), wherein the number of connection points 2241 on the perforated borders 224 is determined by the needed tearing strength for separating from the roll;
(c) a process S05 of winding up in which the strip of facemasks 221 are continuously wound around a core 21 (shown in FIG. 2) on a winder system; and
(d) a process S06 in which step (a) S01 to step (c) S05 is repeated until the pre-determined quantity of the face masks are collected, reaching the purpose for providing a facemask roll 2.
   The perforated border 224 is designed to be easily torn off. Thus, it is convenient for the user to grip and tear apart one or more facemasks from the border lines 224 and then separate the mask(s) 221 from the roll.

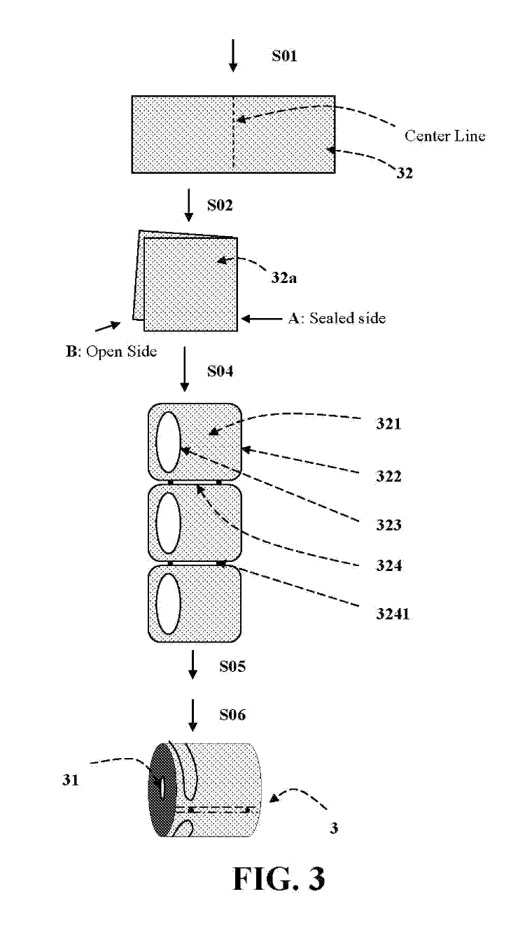

FIG. 3 shows a perspective view of the second embodiment in accordance with the invention. The method comprises steps mostly similar to those of the first embodiments but it is specialized in that the plane facemasks are in folded form. The method comprising an additional step, after S01, of S02 of layering and folding in which one piece of full-width elastic nonwoven fabric is folded symmetrically along its laterally central line, or alternatively two pieces of same size half-width elastic nonwoven fabric are layered symmetrically and sealed on one side to become a folded double layer 32a with a folded side A and an open side B; the process followed is S04 of die cutting, in which the fabric 32a is passed through a molded die to cut the outlines 322 of the mask and ear-loop line 323 to form a folded plane facemask 321 with perforated adjacent border 324 and multiple connection point(s) 3241 (shown in FIG. 3); the strip of folded facemask 321 is then continuously wound around a core 31 to make a facemask roll 3 with a pre-determined quantity of the face masks.

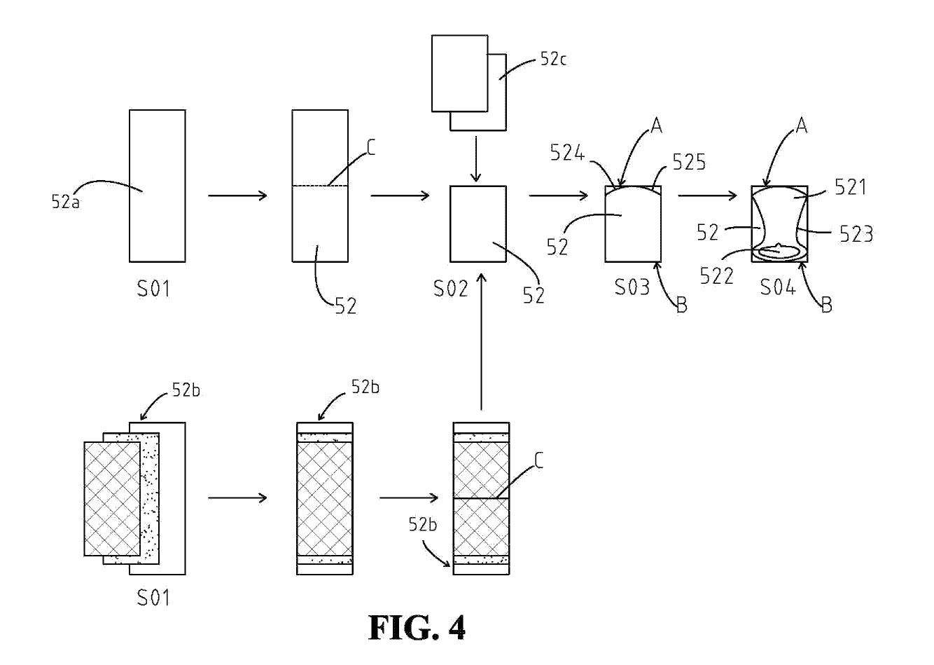

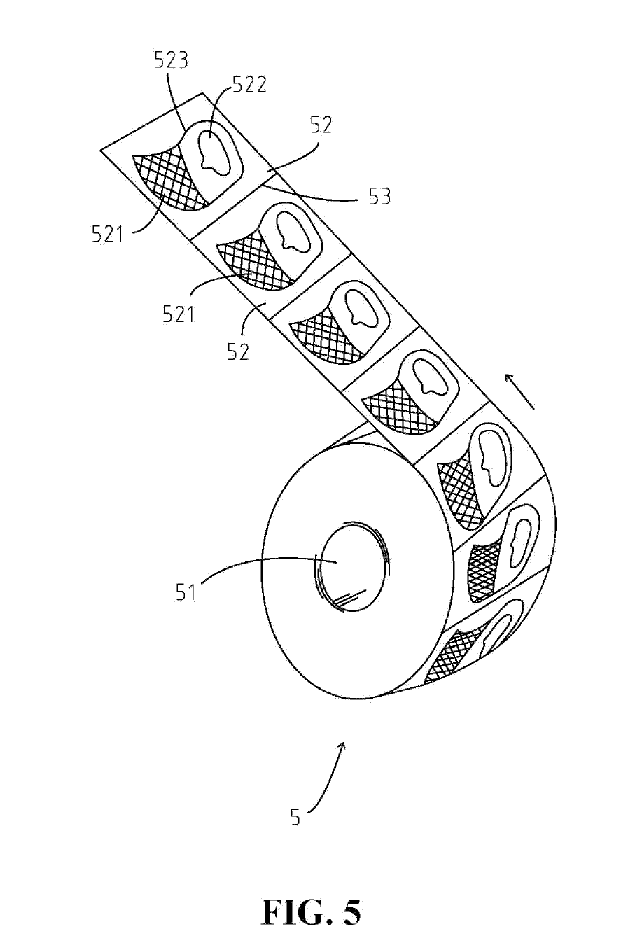

With reference to FIG. 1 and FIG. 4, FIG. 4 shows the manufacturing schematic view to make one butterfly folded type facemask and omit the part of making successive pieces. The invention describes the method comprising the following steps:
(a) a process S01 of feeding in which the elastic fabrics are delivered continuously with an unwinding system;
(b) a process S02 of layering and folding in which one piece of full-width elastic nonwoven fabric 52a or multiple pieces of full width elastic nonwoven fabric 52b are layered together and folded symmetrically along its laterally central line C, or alternatively two pieces of same size half-width elastic nonwoven fabric 52c are layered symmetrically and sealed on one side to become a folded double layer 52 with a folded side A and an open side B, wherein each piece of fabric used could be one or multiple layered construction;
(c) a process S03 of welding and sealing in which an upper side line (nose line 524) and a lower side line (chin line 525) of the facemask on the A side of the folded fabric 52 are welded with a thermal or ultrasonic method;
(d) a process S04 of die cutting in which the folded fabric 52 after welding and sealing is passed through a molded die to cut the outlines 523 of the mask and ear-loop line 522 to form a complete butterfly folded facemask 521 and a plurality of adjacent border lines 53 (shown in FIG. 5), wherein the perforated pattern of the adjacent border lines 53 are designed to be torn apart easier than tearing off the mask trims;
(e) a process S05 of winding (shown in FIG. 5) in which the strip of outlined facemasks 521 with adjacent border lines 53 is continuously fed into a winder to make a roll around a core 51; and
(f) a process S06 in which step (a) S01 to step (e) S05 is repeated until the pre-determined quantity of the face masks are collected, reaching the purpose for providing a facemask roll 5 (shown in FIG. 5).

Moreover, in the step (d) S04, the outlines of the facemask bodies are die cut in the perforated form that are able to be torn off. Thus, it is easy and convenient for the user to grip and tear apart one or more facemasks from the border lines 53 and then separate the mask(s) 521 from the trims inside of the ear-loop line 522 and between the mask outlines 523 and the adjacent border lines 53.

With reference to FIG. 5, it shows a perspective view of the third embodiment in accordance with the invention. The face mask roll 5 relating to the embodiment includes a plurality of butterfly folded facemasks having a multiple layered mask body 521 with extended ear-loops 522 on the end. The facemasks of the roll 5 are characterized by being folded symmetrically and connected successively to each other. Thus, the facemask roll 5 is made up with a plurality of molded facemasks 521 in a continuous flat strip and folded form. The butterfly folded facemasks can be dispensed continuously from the facemask roll 5 by tearing from the adjacent border lines 53.

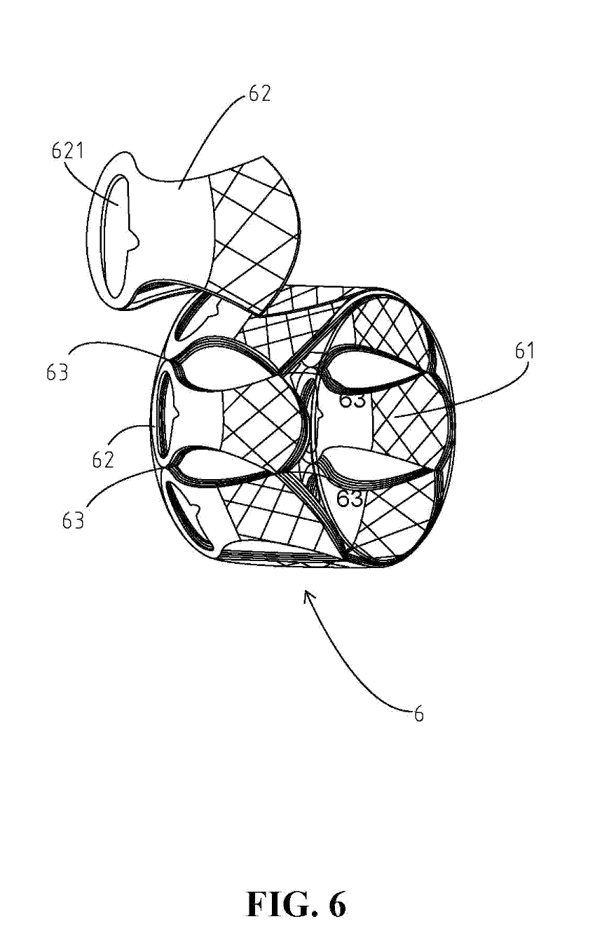

With reference to FIG. 1 and FIG. 6, they are respectively a schematic view of the preferred embodiment in accordance with the invention and a perspective view of the fourth preferred embodiment in accordance with the invention. The fourth embodiment discloses another method of manufacturing a facemask roll of the present invention, and it comprises steps mostly similar to those of the third embodiments but specialized in that the facemasks 62 are connected to each other without trims. Accordingly, in the step (c) S03, not only an upper side line (nose line) and a lower side line (chin line) of the facemask but also each adjacent point 63, which connects one mask to the next one, is welded. In the following step (d) S04, the outlines of the mask and the ear-loop 621 are cut completely, then go into an additional step of (d1) S041, a punching process to remove trims. Afterwards, it continues to go on to the processes of step (e) S05 and step (f) S06, and a strip of butterfly folded facemasks 62 are wound around a core 61 to make a roll 6 providing the purpose of continuously collecting and conveniently dispensing the masks. Each mask 62 can be dispensed one by one continuously from the roll 6 by tearing apart from the connecting points 63 and without the necessity of separating the trims.

The preferred embodiments disclosed are only for illustrating the present invention, and not for giving any limitation to the scope of the present invention. It is apparent to those skilled persons in this art that various modifications or changes can be made to the present drawings without departing from the spirit and scope of this invention. Accordingly, all such modifications and changes also fall within the scope of protection of the appended claims.

The invention is capable of other embodiments and of being practiced and carried out in various ways. Also, it is to be understood that the phraseology and terminology employed herein are for the purpose of description and should not be regarded as limiting.

What is claimed is:

1. A facemask roll includes a plurality of masks made of elastic nonwoven fabric having a center filtration body with extended ear-loops on two ends, wherein the facemask roll is characterized by the fact that facemasks are connected successively to each other and wound around a core to make a roll.

2. The facemask roll of claim 1 wherein the elastic nonwoven fabric is selected from a group of thermally bonded and entangled nonwoven webs and their film laminates, with single or multiple layered constructions.

3. A facemask roll of plane masks which is made by the method comprising the sequential steps of:
(a) a process of feeding in which a piece of elastic nonwoven fabric is delivered by an unwinding system;
(b) a process of die-cutting in which outlines of the plane rectangular strip facemask, the extended ear-loops, and the adjacent border lines between masks are molded;
(c) a process of winding in which a plurality of facemasks in a continuous flat strip can be wound on a core;
(d) a process of finishing in which a determined quantity of facemasks can be counted and separated to make a mask roll.

4. The facemask roll of claim 3 wherein the elastic nonwoven fabric is selected from a group of thermally bonded and entangled nonwoven webs and their film laminates, with single or multiple layered constructions.

5. A facemask roll of folded plane masks which is made by the method comprising the sequential steps:
(a) a process of feeding in which at least one or multiple pieces of elastic nonwoven fabrics can be delivered;
(b) a process of layering and folding in which one piece of full width elastic nonwoven fabric can be folded symmetrically along its laterally central line, or two pieces of half width elastic nonwoven fabric can be layered together and sealed on one side to become a folded double layer;
(c) a process of die-cutting in which outlines of the facemask, ear-loops, and the adjacent border lines between masks can be made.
(d) a process of winding in which a plurality of folded facemasks in a continuous flat strip can be wound on a core;
(e) a process of finishing in which a determined quantity of facemasks can be counted and separated to make a mask roll.

6. The facemask roll of claim 5 wherein the elastic nonwoven fabric is selected from a group of thermally bonded and entangled nonwoven webs and their film laminates, with single or multiple layered constructions.

7. A facemask roll of butterfly folded type masks made by the method comprising the sequential steps:
(a) a process of feeding in which at least one or multiple pieces of elastic nonwoven fabrics can be delivered;
(b) a process of layering and folding in which one piece of full width elastic nonwoven fabric can be folded symmetrically along its laterally central line, or two pieces of half width elastic nonwoven fabric can be layered together and sealed on one side to become a folded double layer;
(c) a process of welding and sealing in which the double-layered folded-form elastic nonwoven fabric can be welded and sealed on an upper side line (nose line) and a lower side line (chin line) to form a filtration cup of the facemask;
(d) a process of die-cutting in which perforated outlines of the facemask, ear-loops, and the adjacent border lines between masks can be made.
(e) a process of winding in which a plurality of folded facemasks in a continuous flat strip can be wound on a core;
(f) a process of finishing in which a determined quantity of facemasks can be counted and separated to make a roll.

8. The facemask roll of claim 7 wherein the elastic nonwoven fabric is selected from a group of thermally bonded and entangled nonwoven webs and their film laminates, with single or multiple layered constructions.

9. A facemask roll of butterfly folded type masks made by the method comprising the sequential steps:
(a) a process of feeding in which at least one or multiple pieces of elastic nonwoven fabrics can be delivered;
(b) a process of layering and folding in which one piece of full width elastic nonwoven fabric can be folded symmetrically along its laterally central line, or two pieces of half width elastic nonwoven fabric can be layered together and sealed on one side to become a folded double layer;
(c) a process of welding and sealing in which the double-layered folded-form elastic nonwoven fabric can be welded on an upper side line (nose line) and a lower side line (chin line) to form a filtration cup of the facemask, and the connecting points between adjacent masks are also made;
(d) a process of die-cutting in which outlines of the facemask and ear-loops can be molded.
(e) A process of punching to remove trims between masks and inside of ear-loops.
(f) a process of winding in which a plurality of folded facemasks in a continuous flat strip can be wound on a core;
(g) a process of finishing in which a determined quantity of facemasks can be counted and separated to make a roll.

10. The facemask roll of claim 9 wherein the elastic nonwoven fabric is selected from a group of thermally bonded and entangled nonwoven webs and their film laminates, with single or multiple layered constructions.
